(19) United States
(12) Patent Application Publication
(10) Pub. No.: US 2014/0030127 A1
(43) Pub. Date: Jan. 30, 2014

(54) VALVE, IN PARTICULAR AN OUTLET VALVE OF A HYDRAULIC PISTON PUMP

(71) Applicants: Reiner Fellmeth, Besigheim (DE); Oliver Gaertner, Absatt (DE); Heiko Jahn, Tamm (DE); Marc Zimmermann, Sonthofen (DE); Harald Hermann, Friolzheim (DE); Rolf Stotz, Vaihingen (DE); Daniel Glosse, Berlin (DE)

(72) Inventors: Reiner Fellmeth, Besigheim (DE); Oliver Gaertner, Absatt (DE); Heiko Jahn, Tamm (DE); Marc Zimmermann, Sonthofen (DE); Harald Hermann, Friolzheim (DE); Rolf Stotz, Vaihingen (DE); Daniel Glosse, Berlin (DE)

(73) Assignee: Robert Bosch GmbH, Stuttgart (DE)

(21) Appl. No.: 13/989,500

(22) PCT Filed: Oct. 11, 2011
(86) PCT No.: PCT/EP11/67731

§ 371 Date: Oct. 11, 2013

(30) Foreign Application Priority Data
Nov. 30, 2010 (DE) 102010062174.9

(51) Int. Cl. F16K 15/02; F04B 53/10

(52) U.S. Cl. CPC F16K 15/026; F04B 53/10
USPC 417/559; 137/537

(57) ABSTRACT

A valve, in particular an outlet valve of a hydraulic piston pump for delivering a fluid, includes a valve seat, a valve closing body, and a guide mechanism. A valve orifice is formed in the valve seat and has an inner wall. The valve closing body is arranged on the valve seat and is configured to selectively open and close the valve orifice. The guide mechanism is configured to guide the valve closing body relative to the valve seat and extends into the valve orifice. The guide mechanism has at least one fluid-conducting recess and at least one region configured to bear against the inner wall of the valve orifice to guide the valve closing body.

### PRIOR ART

The invention relates to a valve, in particular an outlet valve of a hydraulic piston pump for delivering a fluid, having a valve seat, in which is formed a valve orifice with an inner wall, having a valve closing body, which is arranged on the valve seat and which serves for selectively opening and closing the valve orifice, and having a guide means, which guides the valve closing body relative to the valve seat. The invention furthermore relates to a hydraulic piston pump and to a vehicle brake system.

Hydraulic piston pumps, such as those in vehicle brake systems, generally have ball valves as inlet and outlet valves since these are relatively inexpensive to produce.

Such a valve in the form of a ball valve is usually arranged in a valve housing, which is clamped securely on a retainer of a piston that can be extended and retracted in a cylinder. The inlet valve is provided for the purpose of enabling fluid to be drawn into a pressure region within the cylinder through an inlet arrangement by means of a stroke motion of the piston. The fluid is then delivered under pressure out of the pressure region into a hydraulic system through the outlet valve in order to perform work.

The valve housing is generally configured as a cup-shaped cage, within which there is a helical return spring, which pushes against a spherical closing body. As a result, the spherical closing body rests against a valve seat, which is formed on the end of the piston.

When the piston is pushed out of the cylinder by means of a return spring, the closing body of the inlet valve is thus raised from the valve seat counter to the force of the return spring since a vacuum is built up in the cylinder. During this movement of the piston, the inlet valve is opened and fluid is drawn into the pressure region via the inlet arrangement.

When the piston is pushed into the cylinder by means of an eccentric, the inlet valve closes and the outlet valve is opened by virtue of the fact that the closing body at that location is raised counter to a spring force of a helical return spring. The fluid is delivered out of the pressure region into a hydraulic system in order to perform work.

DE 10 2008 043 841 A1 discloses a ball valve, in particular a high-pressure valve for high-pressure pumps of fuel injection systems, having a valve ball and a valve seat surface, wherein the valve ball interacts with the valve seat surface to form a sealing seat in order to interrupt a connection between an inlet and an outlet. Here, the valve ball is pressed against the valve seat surface by means of a helical return spring.

DE 10 2004 028 889 A1 furthermore discloses a piston pump for delivering hydraulic fluid, having a cylinder element, a piston that can be moved backward and forward in the cylinder element, and a piston space, in which the hydraulic fluid can be subjected to pressure by means of the piston. The piston pump furthermore comprises an outlet valve and a slot-controlled inlet valve. In the case of the outlet valve, a valve ball as a closing body is pressed against an associated valve seat by means of a disk-shaped return spring.

### DISCLOSURE OF THE INVENTION

According to the invention, a valve, in particular an outlet valve of a hydraulic piston pump for delivering a fluid, having a valve seat, in which is formed a valve orifice with an inner wall, having a valve closing body, which is arranged on the valve seat and which serves for selectively opening and closing the valve orifice, and having a guide means, which guides the valve closing body relative to the valve seat, is provided, wherein the guide means extends into the valve orifice and the guide means has at least one fluid-conducting recess and at least one region which, to guide the valve closing body, rests against the inner wall of the valve orifice.

The hydraulic piston pump preferably comprises a cylindrical piston, which is supported in such a way that it can be extended and retracted in an interior space of a cylinder. A fluid-filled pressure region is provided and sealed off in the interior space of the cylinder. As the piston is extended from the cylinder, a vacuum is built up in the pressure region, and the piston draws fluid into the pressure region via an inlet valve. During retraction, the piston forces the fluid out of the pressure region into a hydraulic system via an outlet valve in order to perform work.

In the present case, the term “fluid” is intended to mean a gas and/or a liquid, such as a hydraulic fluid based on mineral oil or glycol.

The inlet valve and/or the outlet valve is advantageously designed as a valve according to the invention. The valve according to the invention has a valve seat having a valve orifice, a valve closing body and a guide means, which guides the valve closing body relative to the valve seat. The valve seat comprises a front side and a rear side, the term “rear side” of the valve seat being intended to mean the side on which the fluid flows into the valve orifice and the term “front side” being intended to mean the side on which the fluid flows out of the valve orifice. The valve closing body is arranged on the front side of the valve seat and is connected in a manner which allows the transmission of forces to the guide means, which projects into the valve orifice.

During the extension of the piston out of the cylinder, fluid is drawn into the pressure region through the inlet valve owing to the vacuum produced. During this process, the valve closing body is raised from the valve seat over a certain distance, and the fluid flows through the valve orifice into the pressure region. During the extension of the piston out of the cylinder, the outlet valve is closed in a substantially fluidtight manner.

During the retraction of the piston into the cylinder, the inlet valve is closed. Owing to the pressure produced in the pressure region, the valve closing body of the outlet valve is raised, and the valve orifice is opened. Fluid then flows out of the pressure region, along the outlet valve, into a hydraulic system in order to perform work.

According to the invention, the valve comprises a guide means, which is arranged in the valve orifice and is connected to the valve closing body. This guide means positions the valve closing body on the valve seat, that is to say it guides the valve closing body on a defined path during the opening and closing of the valve. During the closing of the valve, the guide means guides the valve closing body, in particular, to a predefined position on the valve seat, where the valve closing body forms a substantially fluidtight closure with the valve seat by means of a sealing surface.

For this purpose, the guide means is preferably designed as a shoulder or section of elongate design arranged on an end of the valve closing body which faces the valve orifice. This elongate shoulder is accommodated within the valve orifice.

The guide means has at least one region which, to guide the valve closing body, rests against an inner wall of the valve orifice. In this arrangement, at least one further region—a fluid-conducting recess—is spaced apart from the inner wall of the valve orifice and enables the fluid to flow through the valve orifice, between the inner wall of the valve orifice and an outer wall of the guide means, when the valve closing body is raised. The guide means is therefore divided into at least two regions, namely into a region which rests against the inner wall of the valve orifice and thereby ensures accurate guidance of the valve closing body in the axial and radial directions and, on the other hand, into a recessed region which—in the case of an outlet valve—makes available a fluid-conducting connection between a compression chamber, i.e. the pressure region, and a high-pressure side, i.e. the hydraulic system.

One advantage of the invention is that, on the one hand, the valve according to the invention ensures a good fluidtight closure, i.e. easy and good closing behavior, and also responds quickly and precisely, even at low pressures. On the other hand, the guide means or the valve closing body connected to the guide means can be produced at low cost. Owing to the very simple construction of the valve according to the invention, production costs can be reduced.

Moreover, the valve according to the invention requires relatively little installation space since a helical return spring and a spherical valve closing body, which are usually arranged on the front side of the valve seat, are eliminated. A space-saving and compact design or construction, especially of an outlet valve, is provided, in which the valve closing body is guided reliably and accurately during opening and closing. Owing to the guidance according to the invention of the valve closing body, unwanted deflection of the valve closing body is prevented, thereby ensuring an improvement in what is termed the “noise performance” of the hydraulic piston pump.

According to an advantageous development of the valve according to the invention, the region for guiding the valve closing body is formed as at least one web, which rests axially against the inner wall of the valve orifice.

A development of this kind makes available a particularly compact and robust construction of the valve according to the invention. This at least one web or rib extends in the longitudinal direction of the valve and is preferably formed as part of the elongate shoulder, which is accommodated within the valve orifice and rests relatively snugly against the inner wall of the valve orifice. The valve closing body is thus guided axially and radially with respect to the valve seat and the valve orifice by means of the at least one web. The position of the valve closing body is precisely defined in the open position.

According to another advantageous development, the guide means has two to five, preferably three, webs, which are spaced apart in a substantially uniform manner.

These webs are arranged alternately with the fluid-conducting recesses. The webs project radially with respect to the guide means and thus delimit the recessed fluid-conducting regions in the axial direction. Owing to the use of a plurality of webs extending in the axial direction, particularly accurate guidance of the valve closing body is ensured.

According to yet another advantageous development, the guide means is of triangular configuration in cross section.

According to this development, the guide means is configured as an elongate shoulder and has three webs extending in the axial direction. In plan view and in cross section, the guide means is of triangular form with rounded edges matched to the inner wall of the valve orifice. A particularly compact and easily produced guide means is thereby created.

If the valve closing body is raised from the valve seat during the opening of the valve, the webs resting against the inner wall of the valve orifice guide the valve closing body, ensuring that the latter essentially does not slip, particularly in the radial direction, and reassumes its original position during a closing operation of the valve, that is to say forms a substantially fluidtight sealing surface with the valve seat.

In an expedient development of the valve according to the invention, the valve comprises a return means, which subjects the valve closing body to a return force that pushes the valve closing body against the valve seat.

The return means, preferably in the form of a return spring, can be configured as a spring wire of elongate configuration or, alternatively, as a flat-wound bending spring, such as a spring ring or spring plate, a leaf spring or, alternatively, a spiral spring. The leaf spring preferably consists of a flat metal strip or metal wire which is preloaded in an arc. The spiral spring is preferably produced from a metal strip or metal wire wound into a spiral in one plane. A spiral spring or indeed a spring ring are particularly easy to install in the valve. The return spring is preferably produced from a spring steel, e.g. from a copper-beryllium alloy.

When there is a suction or pressure on the valve closing body greater than the return force of the return means, the return means is deformed as the valve closing body is raised from the valve seat in accordance with the distance traveled by the valve closing body. The valve closing body is thus subjected to a return force, and therefore closes again quickly and easily.

In another embodiment, the return means is arranged on an outflow side of the valve.

The outflow side of the valve according to the invention is also defined as the front side of the valve or as the front side of the valve seat.

The return means pushes the valve closing body against the valve seat with a defined clamping force from the front side of the valve seat, with the result that the valve orifice is closed in a substantially fluidtight manner in the closed state of the valve. The return means exerts a pressure force on the valve closing body. When a spring of the abovementioned type is used, an optimized valve is created which requires only a small amount of installation space.

If the valve according to the invention is in the form of an outlet valve, the return spring is preferably supported on a shoulder of a valve cover and is held in a fixed location on an end face of the valve closing body that faces away from the valve orifice.

According to another expedient development of the valve according to the invention, the valve closing body is of plate-shaped configuration.

A valve of this kind makes available a plate-shaped valve closing body which has a relatively small height or dimension in comparison with a spherical valve closing body. Owing to the smaller height of such a valve closing body, it is possible to provide an inlet and/or outlet valve which has a very small dead volume, thereby increasing the efficiency of the hydraulic piston pump.

As an option, the valve closing body can also be configured as a spherical cap, i.e. as a particular spherical segment or a particular portion of a sphere, as a hemisphere or even as a cone.

The valve closing body can furthermore comprise a support on the outflow side of the valve, on which the return means is supported on the valve closing body.

This support is preferably configured as a “support shape”, which can have an annular boss structure or, alternatively, an annular structure in the form of a shoulder, for example, which retains the return means and prevents the return means from slipping.

According to another advantageous development of the valve according to the invention, the valve closing body and the guide means are formed integrally as an injection molding.

A development of this kind makes available what is termed a valve closing body/guide means unit which is formed as an injection molding formed from plastic. By virtue of its shape, an injection molded plastic unit of this kind is particularly suitable for forward mounting on a valve seat and into a hydraulic piston pump and can therefore be assembled easily with other components in the production process. Moreover, a valve of this kind can be produced in a robust and low-cost manner. However, the guide means and, in particular, the valve closing body/guide means unit can also be produced from metal.

The valve closing body furthermore preferably comprises a latching means on the side facing away from the guide means.

This latching means enables the valve closing body to latch into another component, e.g. a spring. In this way, what is termed forward mounting of the valve, in particular, is technically feasible. Thus, the complete valve can be produced first of all as a preassembled unit and then caulked to a pump cylinder.

The object according to the invention is furthermore achieved by means of a hydraulic piston pump having a valve according to the invention.

The hydraulic piston pump according to the invention comprises a cylinder and a piston which can be extended and retracted in the cylinder. A fluid-filled pressure region is formed in the interior space of the cylinder. As the piston is extended from the cylinder, a vacuum is built up in the pressure region, and the piston draws fluid into the pressure region via an inlet valve. During retraction, in contrast, the piston forces the fluid out of the pressure region into a hydraulic system via an outlet valve in order to perform work.

The inlet and/or outlet valve is advantageously configured as a valve according to the invention in accordance with the abovementioned features and advantages. On the one hand, a valve of this kind ensures a high degree of robustness and good sealing behavior. On the other hand, a valve of this kind can be produced at low cost and can be integrated easily into the hydraulic piston pump.

In particular, the guide means according to the invention requires only a small installation space; a relatively large helical return spring in accordance with the prior art, which is arranged on the front side of the valve seat, can be eliminated. A valve of compact and space-saving construction, which ensures good guidance of the valve closing body, is provided. Owing to the guidance of the valve closing body, unwanted deflection of said valve closing body is prevented, and therefore an improvement in the noise performance is achieved.

Finally, a vehicle brake system having a hydraulic piston pump according to the invention is made available.

The vehicle brake system according to the invention comprises a hydraulic piston pump having a valve according to the invention in accordance with the features and advantages explained above.

A vehicle brake system of this kind can be an antilock brake system (ABS), a traction control system (TCS), an electronic stability program (ESP) or an electrohydraulic brake system (EHB), for example. It is advantageous, in particular, in such systems if the hydraulic piston pumps have valves which are robust and, at the same time, can be produced at low cost, which ensure a high degree of leaktightness and which provide optimum operation of the brake system with a long service life. A good noise performance is advantageous, in particular.

### BRIEF DESCRIPTION OF THE DRAWINGS

An illustrative embodiment of the solution according to the invention will be explained in greater detail below with reference to the attached drawings, in which:

FIG. 1 shows a longitudinal section through an illustrative embodiment of a valve according to the invention,

FIG. 2 shows the view II of a first illustrative embodiment of a valve closing body/guide means unit according to FIG. 1,

FIG. 3 shows the view III according to FIG. 2 arranged in a valve seat,

FIG. 4 shows a view of a second illustrative embodiment of a valve closing body/guide means unit,

FIG. 5 shows a further view of the second illustrative embodiment of the valve closing body/guide means unit according to FIG. 4,

FIG. 6 shows a view of a third illustrative embodiment of a valve closing body/guide means unit,

FIG. 7 shows a view of a fourth illustrative embodiment of a valve closing body/guide means unit, and

FIG. 8 shows a longitudinal section through the valve closing body/guide means unit according to FIG. 7, arranged in a valve seat.

### DESCRIPTION OF EMBODIMENTS

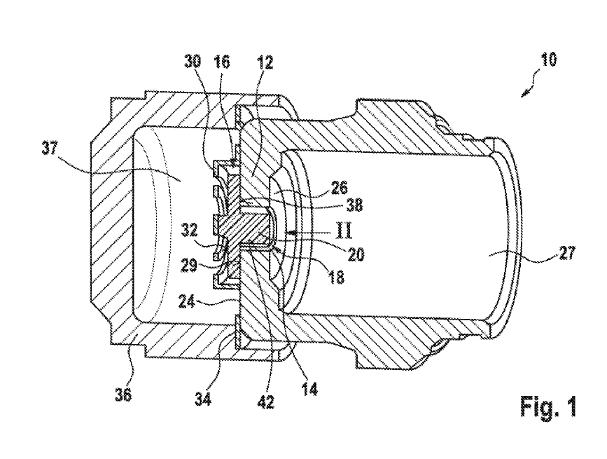

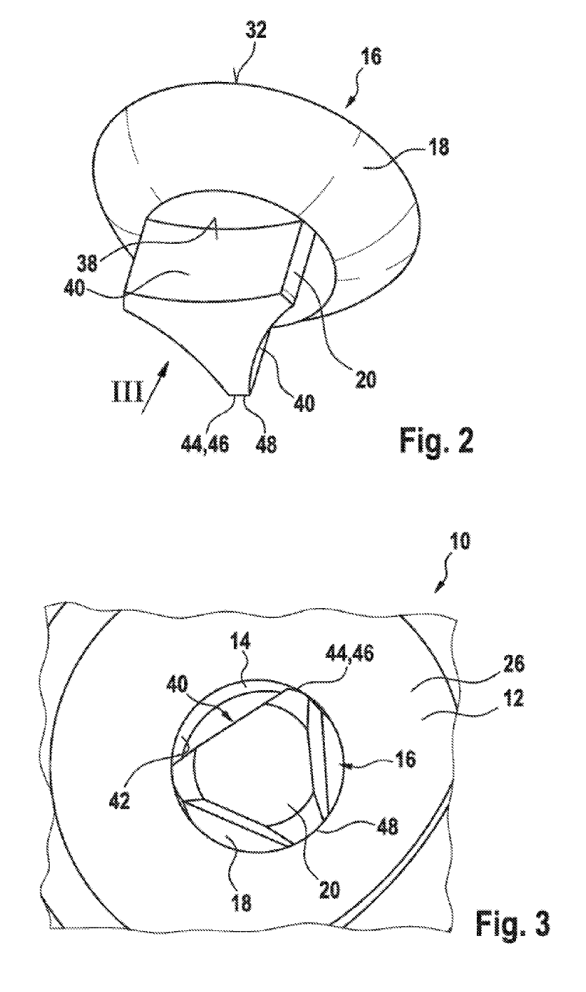

FIG. 1 shows an outlet valve 10 of a hydraulic piston pump of a vehicle brake system. The valve 10 comprises a valve seat 12, in which a circular valve orifice 14 is formed. The valve 10 furthermore comprises a valve closing body/guide means unit 16 (cf. also FIG. 2), which is molded integrally as a plastic injection molding from a plate-shaped valve closing body 18 and a guide means 20.

The valve seat 12 has a front side 24 and a rear side 26, the front side 24 being defined as the side on which the fluid, in the present case a brake fluid, flows into the valve orifice 14, and the rear side 26 being defined as the side on which the fluid flows out of the valve orifice 14.

The hydraulic piston pump comprises a piston which can be extended and retracted in a cylinder and is driven by means of an eccentric. When the piston extends from the cylinder, a vacuum is produced in a pressure region 27, i.e. in a compression chamber 27, within the cylinder. As a result, an inlet valve is opened and fluid flows into the pressure region 27. As the piston retracts into the cylinder, the fluid is subjected to pressure in the pressure region 27 and pressed against the valve closing body/guide means unit 16 of the outlet valve 10.

The valve closing body 18 is arranged on the front side 24 of the valve seat 12, i.e. on the outflow side 24 of the valve 10, to allow selective opening and closing of the valve orifice 14. The region in which the valve closing body 18 rests on the valve seat 12 in the closed state of the valve 10 forms a sealing surface 29, which ensures a substantially fluidtight closure.

The valve closing body 18 is subjected to a return force by means of a return means 30, in the present case a spiral spring 30, which presses the valve closing body 18 against the front side 24 of the valve seat 12. The spring 30 is arranged on the outflow side 24 of the valve 10 and thus exerts a pressure force on the valve closing body 18. In this arrangement, the spring 31 is supported on an end face 32 of the valve closing body 18 which faces away from the valve orifice 14 and is held against a shoulder 34 of a valve cover 36.

When the pressure exerted on the valve closing body 18 is greater than the return force of the spring 30, the valve closing body 16 is raised from the valve seat 12, and the fluid is carried into a hydraulic system—to what is termed the high-pressure side 37—in order to perform work. The outlet valve 10 thus separates the compression chamber 27 from the high-pressure side 37.

During the opening and closing of the valve 10, the guide means 20 guides the valve closing body 18 relative to the valve seat 12.

For this purpose, the guide means 20 is formed as a cylindrical shoulder 20, which starts on the end face of the valve closing body 18 facing the valve orifice 14 and extends into the valve orifice 14. The guide means 20 is accommodated in the valve orifice 14 in such a way that it is spaced apart from an inner wall 42 of the valve orifice 14 by means of three fluid-conducting recesses 40. On the other hand, three regions 44 arranged alternately with the fluid-conducting recesses 40 rest against the inner wall 42 of the valve orifice 14 (cf. FIGS. 2 and 3). These regions 44 are provided for the purpose of guiding the valve closing body 18 in the axial and radial directions during opening and closing and for positioning it exactly on the valve seat 12. The valve closing body 18 is guided over a defined distance. Owing to the guidance of the valve closing body 18 in this way, unwanted deflection of the valve closing body 18 is prevented, ensuring an improvement in the “noise performance” of the hydraulic piston pump.

When the valve closing body 18 is raised from the valve seat 12, the fluid flows along the fluid-conducting recesses 40 through the valve 10.

In FIGS. 2 and 3, the valve closing body/guide means unit 16 is shown on an enlarged scale. The guide means 20 is triangular in cross section. The regions 44 for guiding the valve closing body, which rest against the inner wall 42 of the valve orifice 14, are in the present case formed as three webs 46, which are spaced apart in a substantially uniform manner and extend in the axial direction. During the opening and closing of the valve, these webs 46 therefore slide in the longitudinal direction of the valve orifice 14, past the inner wall 42 thereof. In this case, the outer edges 48 of the webs 46 of the triangular guide means unit 20 are matched to the inner wall 42 of the valve orifice 14, i.e. are arched in the direction of the wall 42.

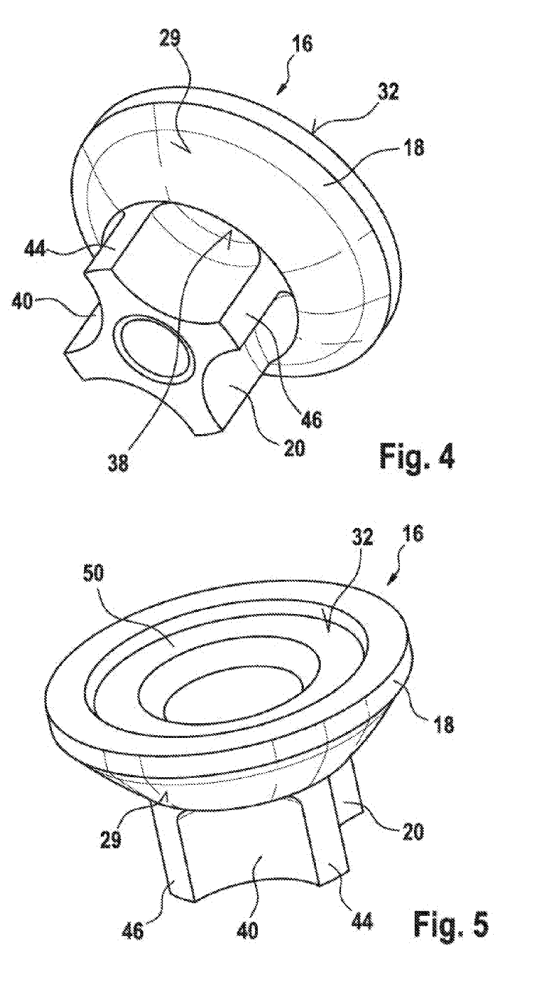

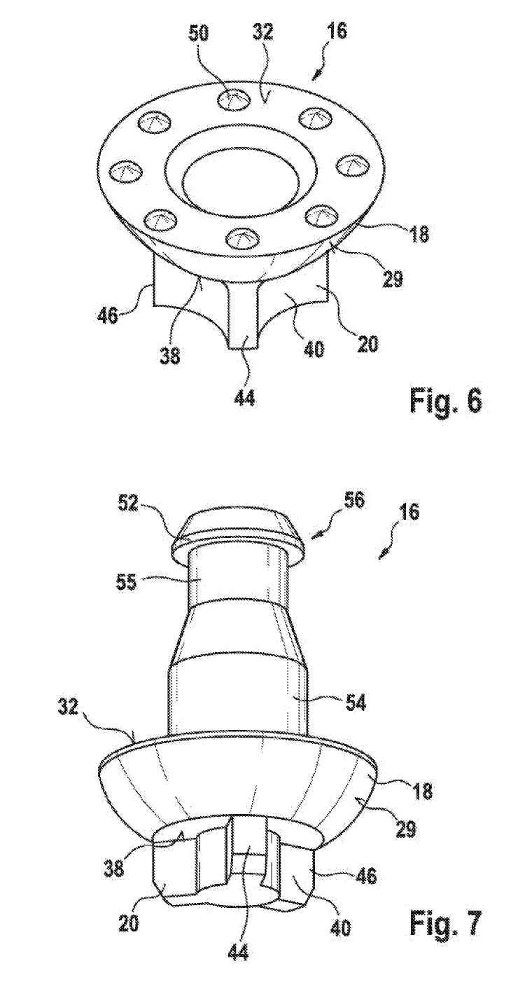

FIGS. 4, 5 and 6 show further illustrative embodiments of a valve closing body/guide means unit 16. The units 16 illustrated here comprise a support 50 on the outflow side 24 of the valve 10, on which the return means 30 is supported on the valve closing body 18. The valve closing body/guide means unit 16 according to FIGS. 4 and 5 has an annular structure which is in the form of a shoulder or step. In FIG. 6, in contrast, a support 50 is shown in which a total of 8 bosses are distributed over the end face 32 in a circle at regular intervals as an annular boss structure. The support 50 prevents the return means 30, e.g. a cylindrical coil spring, from slipping on the end face 32 of the valve closing body 18.

The guide means 20 of the valve closing body/guide means unit 16 according to FIGS. 4 to 6 each comprise four webs 46, which are arranged alternately with four fluid-conducting recesses 40.

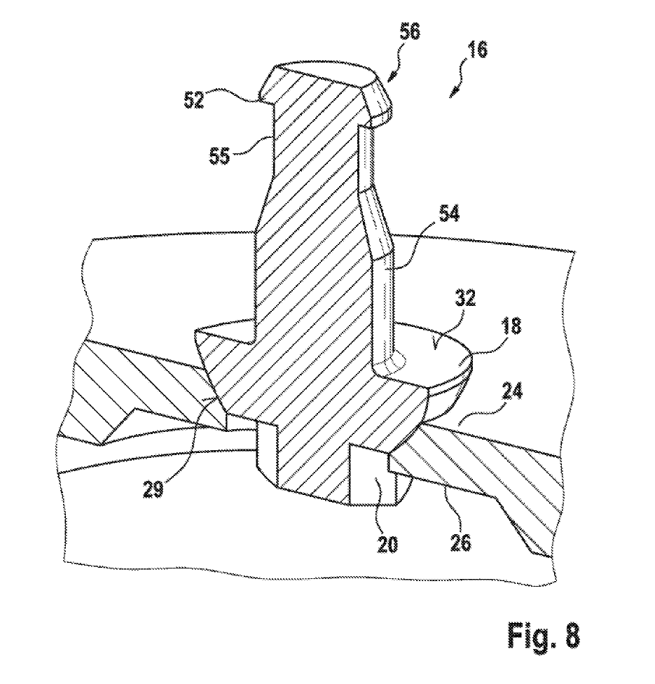

The valve closing body/guide means unit 16 illustrated in FIGS. 7 and 8 comprises a valve closing body 18 in which a latching means 52 is arranged on the side facing away from the guide means 20. This latching means 52 has a cylindrical shoulder 54, which tapers over a defined section 55. A latching mechanism 56, which is provided for the purpose of latching into a spring or, alternatively, into some other component, is formed on the cylindrical shoulder 54 at the opposite end from the valve closing body 18. In particular, this allows forward mounting of the valve 10. During this process, the valve 10 is preinstalled as a separate subassembly and is then caulked to a pump cylinder.

A low-cost and robust valve 10 is thus created which ensures a good sealing effect while having an easy, quick and precise closing behavior and which can be integrated easily into a hydraulic piston pump. The valve closing body/guide means unit 16 furthermore has a compact construction, thereby ensuring a space-saving design of the outlet valve 10.

In the present case, the valve 10 according to the invention is illustrated as a plate valve 10 since a valve 10 of this kind ensures a small dead volume in the piston pump. However, other valve geometries are also conceivable, such as spherical-cap, hemispherical or ball valves. Moreover, the valve closing body/guide means unit 16 can also be made of metal.

In conclusion, it should be noted that all the features which are mentioned in the application documents and especially in the dependent claims are also intended to receive protection in their own right either individually or in any combination, despite the formal dependency references to one or more particular claims.

1. A valve, comprising:
a valve seat;
a valve orifice formed in the valve seat and including an inner wall;
a valve closing body arranged on the valve seat and configured to selectively open and close the valve orifice; and
a guide mechanism configured to guide the valve closing body relative to the valve seat,
wherein the guide mechanism extends into the valve orifice and includes at least one fluid-conducting recess and at least one region, the at least one region being configured to rest against the inner wall of the valve orifice to guide the valve closing body.

2. The valve as claimed in claim 1, wherein the at least one region is formed as at least one web configured to rest axially against the inner wall of the valve orifice.

3. The valve as claimed in claim 2, wherein the guide mechanism has at least two webs spaced apart in a substantially uniform manner.

4. The valve as claimed in claim 1, wherein the guide mechanism is configured with a triangular cross section.

5. The valve as claimed in claim 1, further comprising a return mechanism configured to apply a return force to the valve closing body to push the valve closing body against the valve seat.

6. The valve as claimed in claim 5, wherein the return mechanism is arranged on an outflow side of the valve.

7. The valve as claimed in claim 1, wherein the valve closing body is plate-shaped.

8. The valve as claimed in claim 6, wherein:
the valve closing body includes a supporting arrangement on the outflow side of the valve, and
the return mechanism is supported on the supporting arrangement on the valve closing body.

9. The valve as claimed in claim 1, wherein the valve closing body and the guide mechanism are formed integrally as an injection molding.

10. The valve as claimed in claim 1, wherein the valve closing body includes a latching mechanism on a side facing away from the guide mechanism.

11. A hydraulic piston pump, comprising:
a valve including:
a valve seat;
a valve orifice formed in the valve seat and including an inner wall;
a valve closing body arranged on the valve seat and configured to selectively open and close the valve orifice; and
a guide mechanism configured to guide the valve closing body relative to the valve seat,
wherein the guide mechanism extends into the valve orifice and includes at least one fluid-conducting recess and at least one region, the at least one region being configured to rest against the inner wall of the valve orifice to guide the valve closing body.

12. A vehicle brake system, comprising:
a hydraulic piston pump including:
a valve including:
a valve seat;
a valve orifice formed in the valve seat and including an inner wall:
a valve closing body arranged on the valve seat and configured to selectively open and close the valve orifice; and
a guide mechanism configured to guide the valve closing body relative to the valve seat,
wherein the guide mechanism extends into the valve orifice and includes at least one fluid-conducting recess and at least one region, the at least one region being configured to rest against the inner wall of the valve orifice to guide the valve closing body.

13. The valve of claim 1, wherein the valve is an outlet valve of a hydraulic piston pump configured to deliver a fluid.
